(19) United States
(12) Patent Application Publication
(10) Pub. No.: US 2025/0256622 A1
(43) Pub. Date: Aug. 14, 2025

(54) RECONFIGURABLE SEATING FOR A VESSEL

(71) Applicant: REGAL MARINE INDUSTRIES, INC., ORLANDO, FL (US)

(72) Inventors: Paul A. KUCK, Orlando, FL (US); Tak Beom HEOGH, Palm Harbor, FL (US); Carlos RUIZ DEL OLMO, Clearwater, FL (US); Robert THOMPSON, Windermere, FL (US); Solomon BROWN, Orlando, FL (US); Casey MERRITT, Orlando, FL (US); Petie GOODMAN, St. Cloud, FL (US); Spencer MATSUMOTO, St. Cloud, FL (US); Edward BOHNENSTIEHL, Clearwater, FL (US)

(21) Appl. No.: 19/053,734

(22) Filed: Feb. 14, 2025

Related U.S. Application Data
(60) Provisional application No. 63/553,437, filed on Feb. 14, 2024.

(51) Int. Cl. B60N 2/14; B60N 2/02; B60N 2/06; B60N 2/20

(52) U.S. Cl. CPC B60N 2/14; B60N 2/02253; B60N 2/02258; B60N 2/06; B60N 2/20

(57) ABSTRACT

Reconfigurable bench seating for a vessel includes a seatbase plate for a bench seat having a top surface and a lower surface, a swivel assembly secured to the lower surface of the seatbase plate, and a backrest for the bench seat having a first side and an opposing second side. The bench seating also includes a backrest folding assembly configured to fold the backrest between a mostly vertical orientation to a mostly horizontal orientation. The swivel assembly includes a swivel motor having a shaft, and an adapter coupled to the shaft, where the adapter is configured to be rotate in a first direction and an opposing second direction by the swivel motor. The backrest folding assembly comprises a linear actuator and a lever arm, where the lever arm is configured to be rotated in a first direction and an opposing second direction by the linear actuator.

### CROSS-REFERENCE TO RELATED APPLICATIONS

This application claims the benefit of U.S. provisional application No. 63/553,437 filed Feb. 14, 2024, which is hereby incorporated herein in its entirety by reference.

### FIELD

The present invention relates to the field of boating, and, more particularly, to reconfigurable seating for a vessel.

### BACKGROUND

Seating on a vessel includes different seating arrangements on the deck or in the cockpit area of the vessel. The seating may include bench seating, which is often long, cushioned seats to accommodate multiple people comfortably. They can be fixed, or movable depending on the design of the vessel and are usually positioned to provide a good view of the surroundings while motoring or anchored. Bench seating adds both functionality and comfort to the outdoor living space of the vessel, allowing passengers to relax and enjoy the views while cruising.

However, bench seating is not adjustable other than the backrest may be flipped to one side or the other to accommodate forward facing or rear facing positions. Accordingly, there is a need in the art for bench seating that is easily adjustable to accommodate more configurations of the seating area on the vessel.

### SUMMARY

In view of the foregoing background, it is therefore an object of the present invention to provide improved bench seating for a vessel. The reconfigurable bench seating for a vessel of the present invention includes a seatbase plate for a bench seat having a top surface and a lower surface, a swivel assembly secured to the lower surface of the seatbase plate, and a backrest for the bench seat having a first side and an opposing second side. The reconfigurable bench seating also includes at least one backrest folding assembly secured to a first side of the backrest, where the at least one backrest folding assembly is configured to fold the backrest between a mostly vertical orientation to a mostly horizontal orientation. The bench seating may be configured for at least two passengers to sit side by side.

The swivel assembly includes a swivel motor having a shaft, and an adapter coupled to the shaft, where the adapter is configured to be rotate in a first direction and an opposing second direction by the swivel motor. The swivel assembly also includes a slewing ring coupled to the adapter and the seat, where the seat is configured to rotate in a first direction when the adapter moves in the first direction to swivel the seat to a forward facing orientation, and to rotate in an opposing second direction when the adapter moves in the opposing second direction to swivel the seat to a rearward facing orientation.

The backrest folding assembly includes a linear actuator and a lever arm, where the lever arm is configured to be rotated in a first direction and an opposing second direction by the linear actuator. The backrest folding assembly also includes a backrest bracket coupled to the lever arm and a backrest, where the lever arm is configured to rotate in the first direction when the linear actuator moves in the first linear direction to fold the backrest down to the mostly horizontal position, and to rotate in an opposing second direction when the linear actuator moves in the opposing second linear direction to unfold the backrest to the mostly vertical position. The backrest folding assembly may have a first backrest.

The backrest folding assembly may comprise two assemblies. For example, a first backrest folding assembly may be secured to the first side of the backrest, and a second backrest folding assembly may be secured to the second side of the backrest, where the first and second backrest folding assemblies are configured to cooperate to move the backrest.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a perspective view of reconfigurable bench seating for a vessel in which various aspects of the disclosure may be implemented;

FIG. 2 is a perspective view of the reconfigurable bench seating in a rearward facing position;

FIG. 3 is a perspective view of the reconfigurable bench seating with the backrests folded down;

FIG. 4 is a perspective view of the reconfigurable bench seating with helm seating swiveled in a rearward facing position and the bench seating in a forward facing configuration;

FIG. 5 is a top perspective view of a carriage for a first embodiment of a swivel assembly of the reconfigurable bench seating;

FIG. 6 is a bottom perspective view of the carriage for the swivel assembly;

FIG. 7 is an exploded view of a pinion and slewing ring;

FIG. 8 is an exploded view of the slewing ring being secured to a seat base;

FIG. 9 is an exploded view of the first embodiment of the swivel assembly;

FIG. 10 is a bottom perspective view of the swivel assembly;

FIG. 11 is a top perspective view of the swivel assembly;

FIG. 12 is a perspective view of a first embodiment of a backrest folding assembly;

FIG. 13 is an exploded view of the first embodiment of the swivel assembly and the backrest folding assemblies;

FIG. 14 is a perspective view of a final assembly of the first embodiment of the reconfigurable seating for a vessel;

FIG. 15 is top view of a port and starboard side base plates;

FIG. 16 is an assembly of a slewing ring being coupled to the base plate;

FIG. 17 is a perspective view of a swivel motor of a second embodiment of a swivel assembly of the reconfigurable bench seating;

FIG. 18 is a top perspective view of the swivel motor attached to the base plate;

FIG. 19 is an exploded view of the second embodiment of the swivel assembly;

FIG. 20 is a bottom perspective view of the second embodiment of the swivel assembly secured to the base plate;

FIG. 21 is a top perspective view of the second embodiment of the swivel assemble secured to the base plate;

FIG. 22 is a perspective view of a second embodiment of a backrest folding assembly;

FIG. 23 is an exploded view of the second embodiment of the swivel assembly and the backrest folding assemblies; and

FIG. 24 is a perspective view of a final assembly of the second embodiment of the reconfigurable seating for a vessel.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

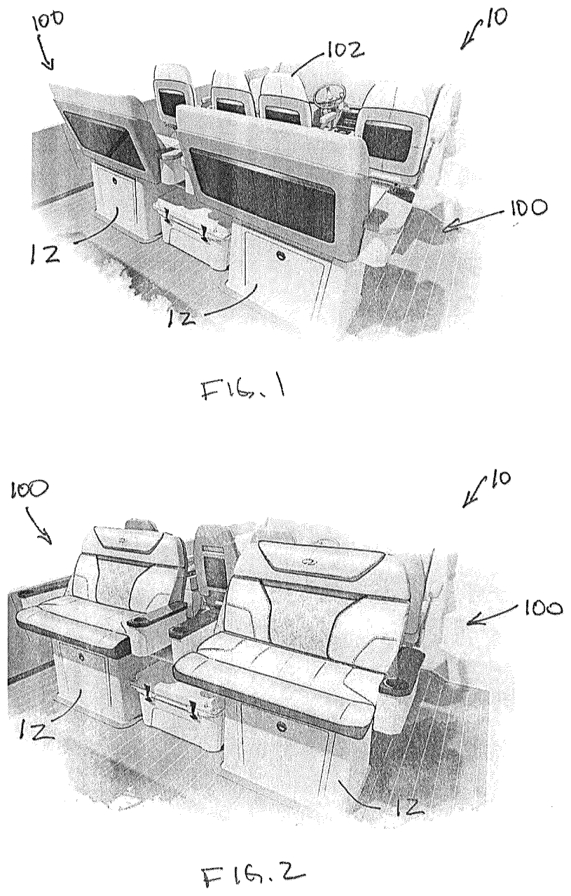

Referring now to FIGS. 1-14, a first embodiment of a reconfigurable bench seating for a vessel is depicted and generally designated 100. The bench seating 100 is shown in a forward facing orientation of the vessel 10 in FIG. 1 and mounted to a support base 12. The bench seating 100 is shown in the rearward facing orientation in FIG. 2 after being swiveled around using the present invention. As those of ordinary skill in the art can appreciate, the present invention can be implemented with any seating such as a helm seat or passenger seat, for example, and is not limited to the bench seating.

As described in more detail below, the seating 100 can move between forward facing and rearward facing, and also the backrest can be folded down using the present invention. For example, the backrests of the seating 100 are folded down in FIG. 3. The backrests can then serve as counter space rather than for seating.

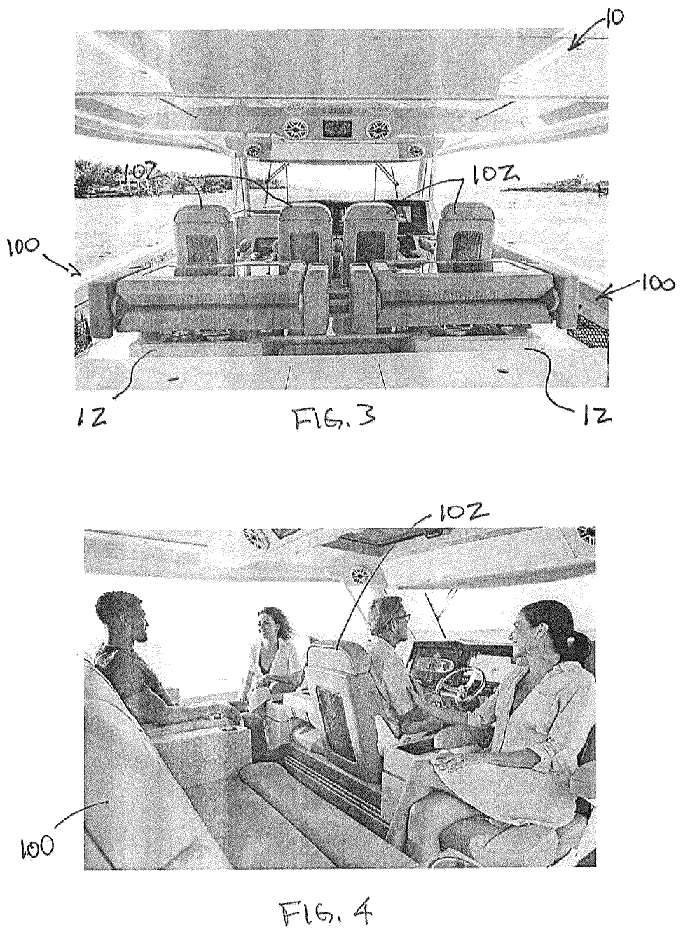

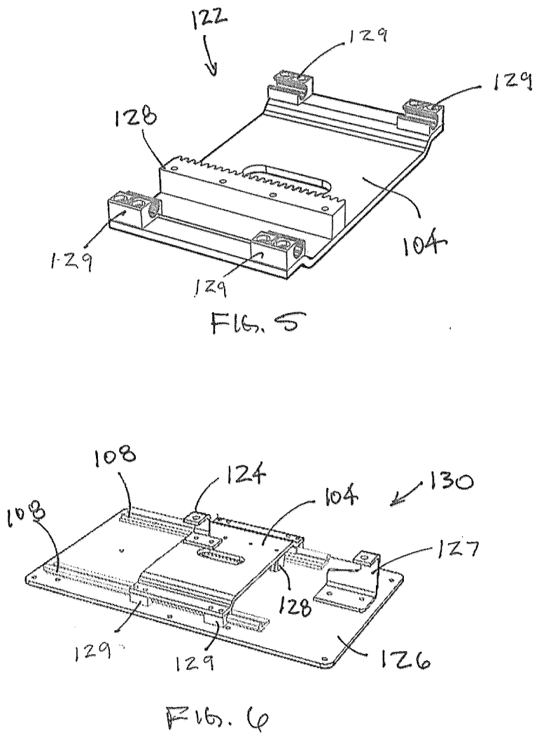

In FIG. 4, two of the front seats 102 have been swiveled to be rearward facing to create face to face conversation between the passengers. Accordingly, the present invention can be used with bench seating as shown in FIGS. 1-3, and also passenger and helm seating as shown in FIG. 4.

Referring now to FIGS. 5 and 6, various components of a rack assembly 130 of the reconfigurable bench seating 100 are depicted. The rack assembly 130 includes a carriage 122 having a planar support 104. A rack 128 and slides 129 are mounted to an upper surface of the planar support 104. The carriage 122 is secured to a pair of rails 108 mounted to a lower base plate 126 using the slides 129 as depicted in FIG. 6.

A first actuator bracket 127 is secured to the lower base plate 126 and a second actuator bracket 124 is secured to a lower surface of the planar support 104. The carriage 122 slidingly engages with the pair of rails 108 using the slides 129 so that the carriage 122 can slide in a first linear direction and an opposing second linear direction to initiate the swivel motion of the seating as described in more detail below.

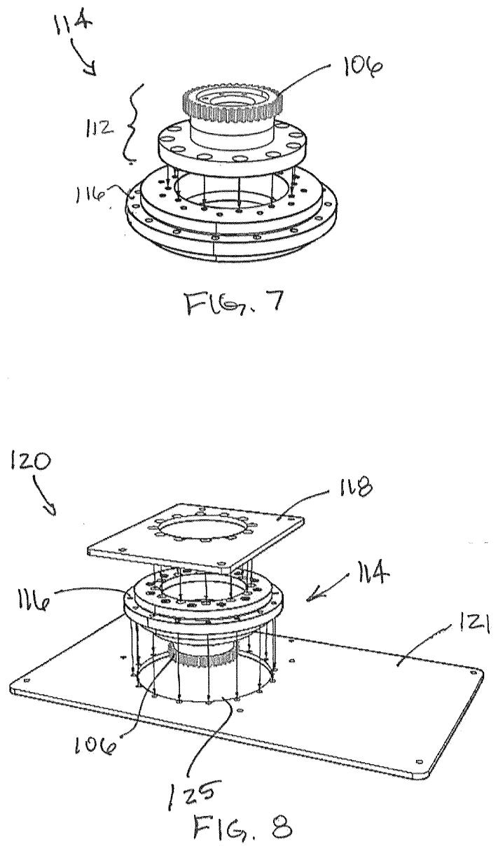

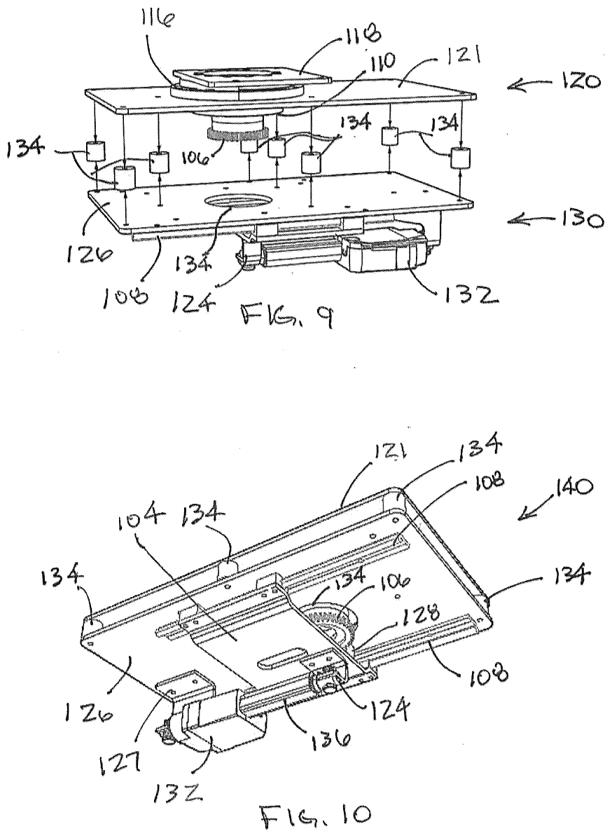

Referring now to FIGS. 7 and 8, the various components of a pinion assembly 114 of the swivel assembly are depicted. The pinion assembly 114 includes a lower pinion assembly 112 and a slewing ring 116. The lower pinion 112 assembly includes a pinion 106 that is configured to be driven by the rack 128. The slewing ring 116 is configured to be secured to a seat adapter 118.

For example, the lower pinion assembly 112 is inserted through an aperture 125 within an upper base plate 121 as depicted in FIG. 8. The pinion 106 extends through the aperture 125 and the slewing ring 116 is secured to the upper base plate 121. A seat adapter 118 is secured to a top of the slewing ring 116. The slewing ring 116 allows for rotational movement of the seat adapter 118 and seating secured thereto as the pinion 106 rotates.

An exploded view of the pinion assembly 120 is depicted in FIG. 9. The pinion assembly 120 and the rack assembly 130 are aligned with the pinion assembly 120 being above the rack assembly 130. The pinion 106 is inserted through lower aperture 134 in order to engage the rack 128. The pinion assembly 120 and the rack assembly 130 are secured together and have spacers 134 separating the upper base plate 121 and the lower base plate 126.

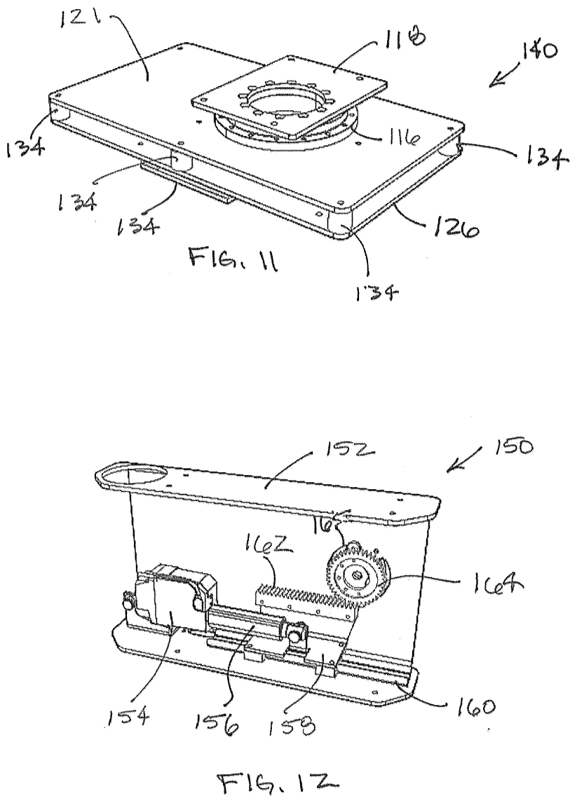

A bottom perspective view of the assembled swivel assembly 140 is depicted in FIG. 10 where the pinion 106 is visible through aperture 134 to engage the rack 128. FIG. 11 is a top perspective view of the swivel assembly 140 where the seat adapter 118 is depicted for securing to seating.

An actuator motor 132 is secured to the lower base plate 126 using the first actuator bracket 127. An actuator arm 125 extends from the actuator motor 132 and is coupled to the planar support 104 of the carriage 122. Accordingly, as the actuator arm 136 is extended or retracted, the rack 128 engages the pinion 106 to rotate, which in turn rotates the seat adapter 118.

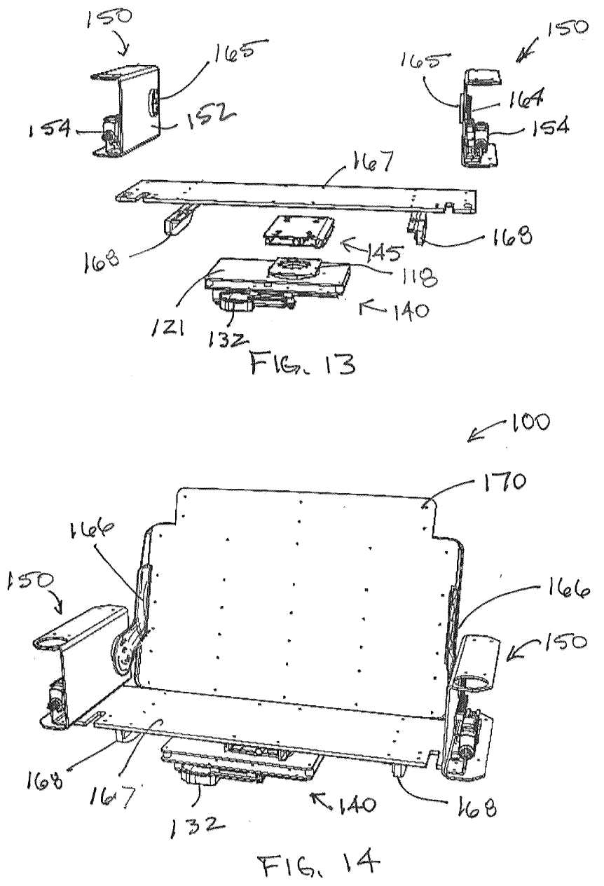

Referring now to FIG. 12, a backrest folding assembly 160 of the reconfigurable bench seating 100 is depicted. The folding assembly 160 is positioned on each side of the seating and serves as an armrest. The folding assembly 150 uses a rack and pinion arrangement similar to the swivel assembly 140 described above.

The backrest folding assembly 150 includes an armrest panel 152 having an actuator motor 154 mounted thereto. An actuator arm 156 extends from the linear actuator 154 and is coupled to a sliding bracket 158. The sliding bracket 158 is slidingly engaged with a rail 160 that is mounted to the armrest panel 152. In addition, an armrest rack 162 is coupled to the sliding bracket 158. Accordingly, as the actuator arm 156 is extended or retracted, the armrest rack 162 moves linearly to rotate a pinion 164. The pinion 164 is secured to the armrest panel 152 using a bearing 165 that passes through the armrest panel 152 from one side to the other to couple to a backrest bracket 166 attached to the backrest 170.

Accordingly, as the actuator arm 156 moves the sliding bracket 158 in a first linear direction, the rack 162 rotates the pinion 164 in a first direction, which in turn moves the backrest 170 to a folded down mostly horizontal position. Similarly, as the actuator arm 156 moves in an opposing second linear direction, the pinion 164 is rotated in a second opposing direction, which in turn moves the backrest 170 to a mostly vertical position.

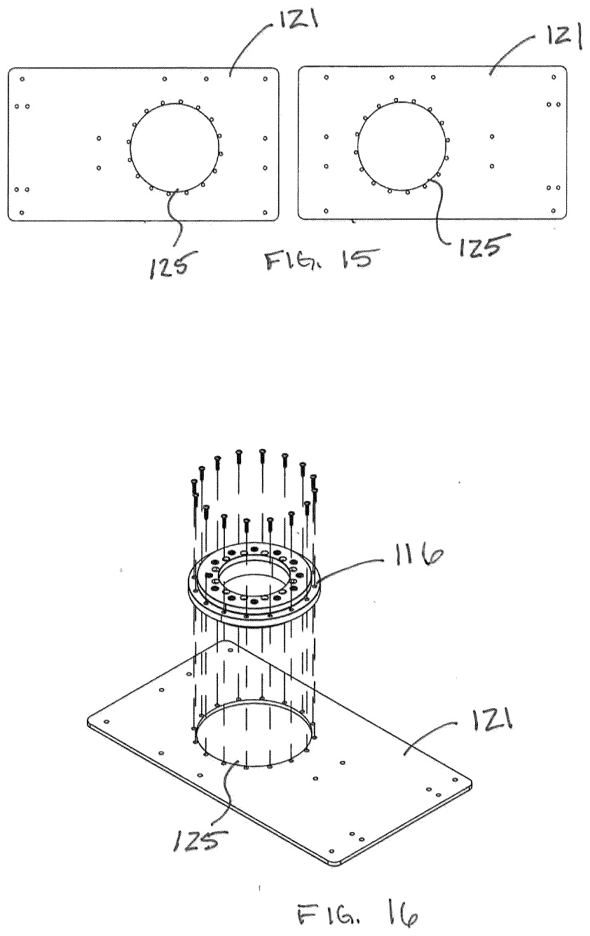

Referring now to FIG. 13, an exploded view of the swivel assembly 140 and the folding assembly 150 of the reconfigurable seating 100 is depicted. The seating 100 includes a seatbase plate 167 and a pair of bottom supports 168 positioned proximate to each end of the seatbase plate 167. In addition, a sliding mechanism 145 may be secured between the seat adapter 118 and the lower surface of the seatplate base 167. The sliding mechanism 145 is configured for the seatbase plate 167 (and seating) to slide forward or backward for adjustment relative to the support bases 12 of the vessel 10. The folding assemblies 150 are secured to an upper surface of each end of the seatbase plate 167, and the swivel assembly 140 is secured to a lower surface of the seatbase plate 167.

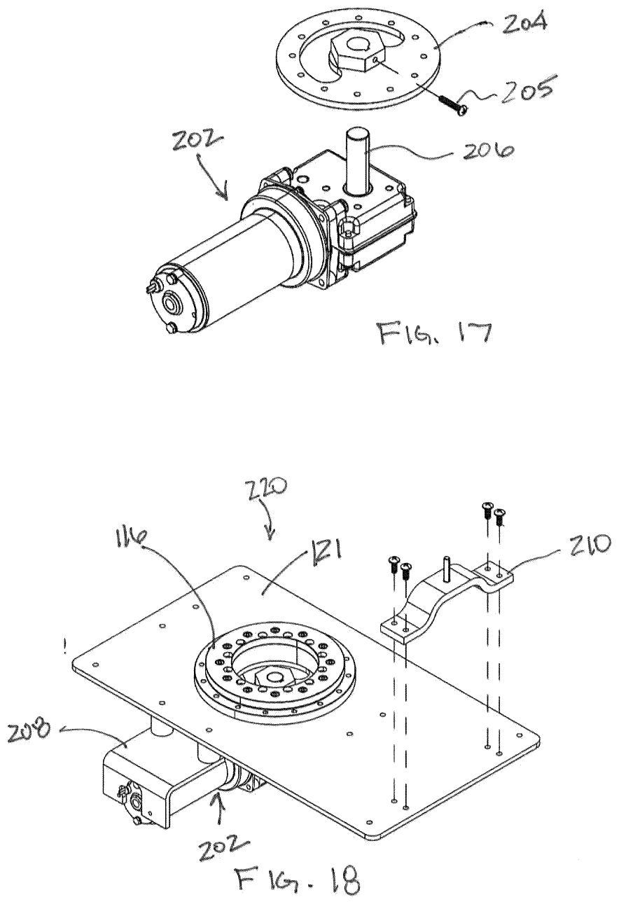

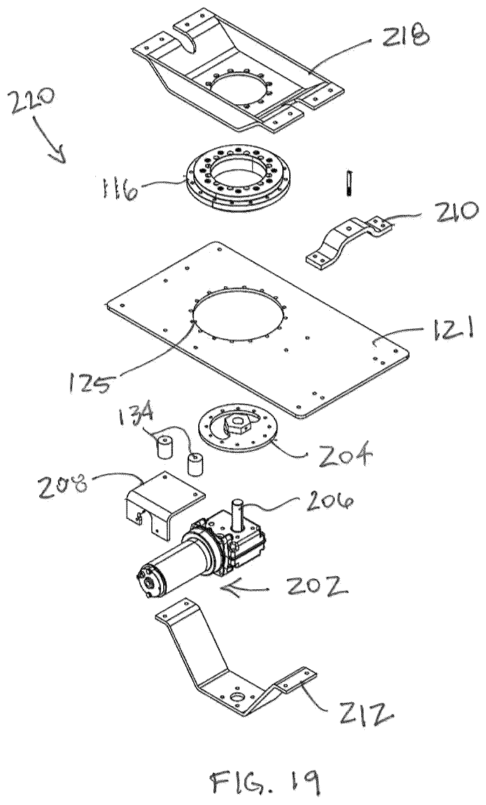

The backrest brackets 166 have a first end secured to the backrest 170, and a second end coupled to the bearing 165 as depicted in FIG. 14. Accordingly, as the pinion 164 is rotated, the backrest brackets 166 are also rotated, which in turn causes the backrest 170 to move in the corresponding direction.

In operation of the reconfigurable bench seating 100, the motion of the swivel assembly 140 is initiated by the actuator 132. The actuator 132 selectively extends or retracts the actuator arm 136, which in turn causes linear motion of the carriage 104 that carries the rack 128. The movement of the rack 128 engages the pinion 106 to cause the seating to rotate to a forward facing orientation, or to rotate in an opposing rearward facing direction.

The backrest folding assemblies 150 cause the backrest 170 to move when the actuator 154 moves the sliding bracket 158 in the first linear direction to rotate the pinion 164 to fold the backrest down to the mostly horizontal position. Similarly, when the actuator 154 moves the sliding bracket 158 in the opposing second linear direction, the pinion 164 rotates in a second opposite direction to unfold the backrest 170 to the mostly vertical position.

Referring now to FIGS. 15-24, a second embodiment of a reconfigurable bench seating for a vessel is depicted and generally designated 200. Similar to the first embodiment described above, a base plate 121 is used and includes an aperture 125 for the slewing ring 116 to be secured as shown in FIGS. 15 and 16.

In the second embodiment, a swivel motor 202 is used to drive a motor shaft 206 as depicted in FIG. 17. The motor shaft 206 is coupled to an adapter 204 and secured with a set screw 205. Referring now to FIG. 18, the swivel motor 202 is shown secured to a bottom surface of the base plate 121 using a motor mount 208, and the adapter 204 is secured to the slewing ring 116. A locking bracket 210 is also secured to a top surface of the base plate.

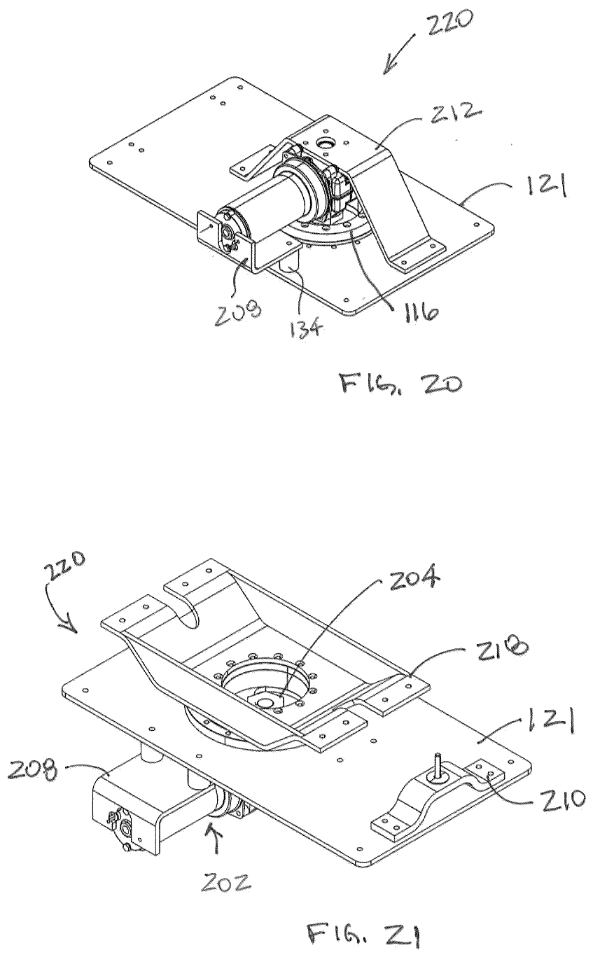

An exploded view of the swivel assembly 220 is depicted in FIG. 19. A bracket 212 along with a motor mount 208 are used to position the swivel motor 202 and shaft 2026 on the bottom surface of the base plate 121. A pair of spacers 134 may be positioned between the motor mount 208 and the base plate 121. As explained above, the adapter 204 is secured to the motor shaft 206, which in turn is secured to the slewing ring 116. The slewing ring 116 is secured to the aperture 125 of the base plate 121, and to a seat support 218.

A bottom perspective view of the swivel assembly 220 is depicted in FIG. 20. The bracket 212 and motor mount 208 are secured to the bottom surface of the base plate 121. Now turning to FIG. 21, the swivel assembly 220 is shown assembled with the seat support 218. The adapter 204 is visible though the aperture of the seat adapter 204. Accordingly, as the adapter 204 is rotated by the swivel motor 202 and shaft 206, the seat support 218 (and seat) is rotated.

Referring now to FIG. 22, a backrest folding assembly 260 of the second embodiment of the reconfigurable bench seating 200 is depicted. The folding assembly 250 is positioned on each side of the seating 167 and serves as an armrest. The folding assembly 250 uses a linear actuator 154 and a lever arm 252 to control movement of the backrest 170 as described in detail below.

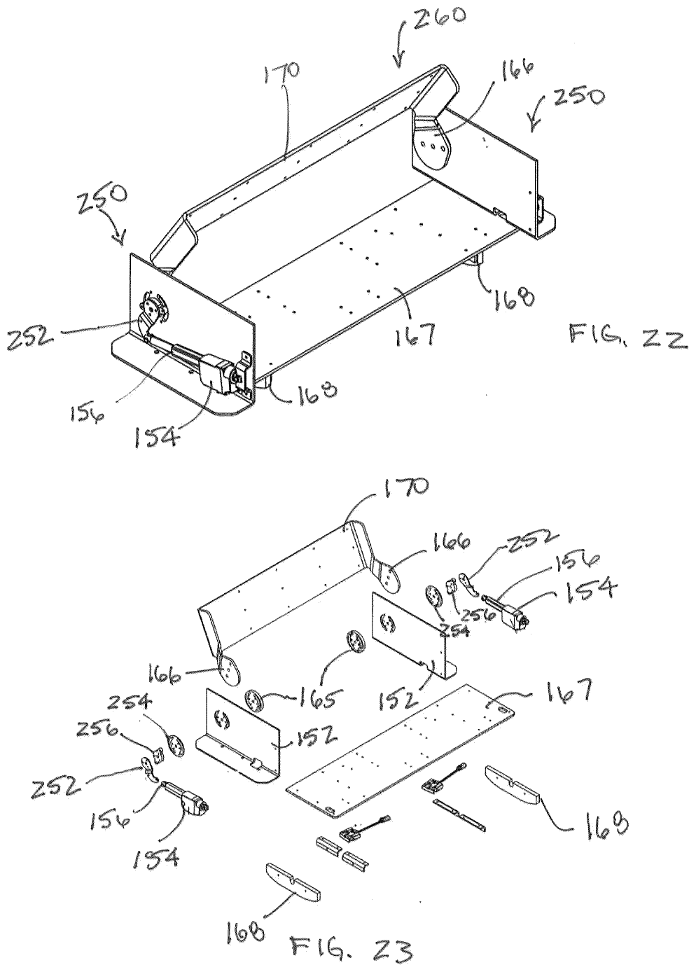

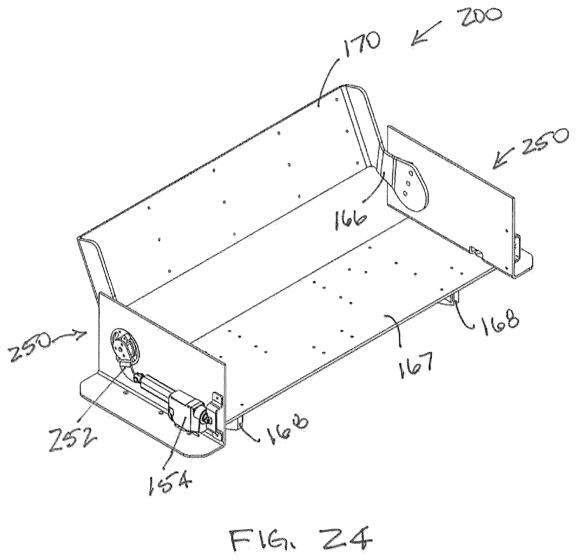

The backrest folding assembly 260 of the second embodiment includes an armrest panel 152 having the linear actuator 154 mounted thereto. An actuator arm 156 extends from the linear actuator 154 and is coupled to a lever arm 252. The lever arm 252 is coupled to a lever arm adapter 256 on an outer side of the armrest panel 152 as depicted in FIG. 23. The lever arm 252 is coupled to the backrest bracket 166 on an inner side of the armrest panel 152. Accordingly, as the actuator arm 156 is extended or retracted, the lever arm 252 is rotated, which rotates the backrest bracket and the backrest 170. For example, as the actuator arm 156 rotates the lever arm 252 in a first direction, the backrest 170 is moved to a folded down mostly horizontal position. Similarly, as the actuator arm 156 moves in an opposing second linear direction, the lever arm 252 is rotated in a second opposing direction, which in turn moves the backrest 170 to a mostly vertical position.

Referring now to FIG. 24, in operation of the second embodiment of the reconfigurable bench seating 200, the motion of the swivel assembly 220 is initiated by the swivel motor 202. The rotating of the motor shaft 206 and adapter 204 causes the seating to rotate to a forward facing orientation, or to rotate in an opposing rearward facing direction.

The backrest folding assemblies 250 cause the backrest 170 to move when the actuator 154 rotates the lever arm 252 in the first direction to fold the backrest down to the mostly horizontal position. Similarly, when the actuator 154 rotates the lever arm 252 in the opposing second linear direction, the lever arm 252 rotates in a second opposite direction to unfold the backrest 170 to the mostly vertical position.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. Reconfigurable bench seating for a vessel comprising:
a seatbase plate for a seat having a top surface and a lower surface;
a swivel assembly secured to the lower surface of the seatbase plate;
a backrest for the seat having a first side and an opposing second side; and
at least one backrest folding assembly secured to a first side of the backrest, wherein the at least one backrest folding assembly is configured to fold the backrest between a mostly vertical orientation to a mostly horizontal orientation.

2. The reconfigurable bench seating of claim 1, wherein the seat is configured for at least two passengers to sit side by side.

3. The reconfigurable bench seating of claim 2, wherein the swivel assembly comprises a swivel motor having a shaft, and an adapter coupled to the shaft, wherein the adapter is configured to be rotate in a first direction and an opposing second direction by the swivel motor.

4. The reconfigurable bench seating of claim 3, wherein the swivel assembly further comprises a slewing ring coupled to the adapter and the seat, wherein the seat is configured to rotate in a first direction when the adapter moves in the first direction to swivel the seat to a forward facing orientation, and to rotate in an opposing second direction when the adapter moves in the opposing second direction to swivel the seat to a rearward facing orientation.

5. The reconfigurable bench seating of claim 4, wherein the at least one backrest folding assembly comprises a linear actuator and a lever arm, the lever arm is configured to be rotated in a first direction and an opposing second direction by the linear actuator.

6. The reconfigurable bench seating of claim 5, wherein the at least one backrest folding assembly further comprises a backrest bracket coupled to the lever arm and a backrest, wherein the lever arm is configured to rotate in the first direction when the linear actuator moves in the first linear direction to fold the backrest down to the mostly horizontal position, and to rotate in an opposing second direction when the linear actuator moves in the opposing second linear direction to unfold the backrest to the mostly vertical position.

7. The reconfigurable bench seating of claim 6, wherein the at least one backrest folding assembly comprises a first backrest folding assembly secured to the first side of the backrest, and a second backrest folding assembly secured to the second side of the backrest, wherein the first and second backrest folding assemblies are configured to cooperate to move the backrest.

8. Reconfigurable bench seating for a vessel comprising:
a seatbase plate for a seat having a top surface and a lower surface;
a swivel assembly secured to the lower surface of the seatbase plate, the swivel assembly comprising,
a swivel motor,
a seat adapter coupled to the seat, wherein the seat adapter is configured to be rotated in a first direction and an opposing second direction by the swivel motor,
wherein the seat adapter is configured to rotate in the first direction to swivel the bench seat to a forward facing orientation, and to rotate in the opposing second direction to swivel the bench seat to a rearward facing orientation.

9. The reconfigurable bench seating of claim 8, wherein the swivel assembly comprises a slewing ring coupled to the seat adapter.

10. The reconfigurable bench seating of claim 9, wherein the slewing ring is mounted to an aperture of the seatbase plate.

11. The reconfigurable bench seating of claim 10, wherein the swivel motor is mounted to a lower surface of the seatbase plate.

12. The reconfigurable bench seating of claim 11, wherein the swivel motor comprises a shaft coupled to the seat adapter.

13. The reconfigurable bench seating of claim 12, wherein the seat adapter comprises a circular shape having a central aperture for receiving the shaft.

14. The reconfigurable bench seating of claim 13, further comprising a seat support coupled to the seat adapter.

15. The reconfigurable bench seating of claim 14, further comprising a seat coupled to the seat support.

16. Reconfigurable seating for a vessel comprising:
at least one seat mounting base secured to deck of the vessel;
seating mounted to the at least one seat mounting base and the seating having a seating surface and a backrest; and
a swivel assembly positioned between the seat mounting base and the seating and configured for the seating to swivel between a forward facing position and a rearward facing position.

17. The reconfigurable seating of claim 16, further comprising at least one backrest folding assembly secured to the backrest, wherein the at least one backrest folding assembly is configured to fold the backrest between a mostly vertical orientation to a mostly horizontal orientation.

18. The reconfigurable bench seating of claim 16, wherein the swivel assembly comprises a swivel motor having a shaft, the shaft is configured to be rotated in a first direction and an opposing second direction by the swivel motor.

19. The reconfigurable bench seating of claim 18, wherein the swivel assembly further wherein the swivel assembly further comprises a an adapter and slewing ring coupled to the adapter and the seating, wherein the seating is configured to rotate in a first direction when the adapter moves in the first direction to swivel the seating to a forward facing orientation, and to rotate in an opposing second direction when the adapter moves in the opposing second direction to swivel the seating to a rearward facing orientation.

20. The reconfigurable bench seating of claim 17, wherein the at least one backrest folding assembly comprises a linear actuator and a lever arm, the lever arm is configured to be rotated in a first direction and an opposing second direction by the linear actuator.
